(19) United States
(12) Patent Application Publication
(10) Pub. No.: US 2005/0034686 A1
(43) Pub. Date: Feb. 17, 2005

(54) Support garment for quadrapeds

(76) Inventor: Joel F. Spatt, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/856,690

(22) Filed: May 28, 2004

Related U.S. Application Data
(63) Continuation of application No. PCT/US02/38071, filed on Nov. 27, 2002.
(60) Provisional application No. 60/334,210, filed on Nov. 30, 2001.

(51) Int. Cl. A01K 15/04; A47B 47/00

(52) U.S. Cl. 119/816

(57) ABSTRACT

The present invention relates to a support garment for quadrupeds. the support garment of the present invention includes a neoprene laminated fabric material that includes support channels that allow for insertion of support rods. The support garment of the invention is effective for adjustably limiting unwanted or abnormal joint motion an injured leg while promoting normal movement against resistance.

This application is a continuation application of PCT/US02/38071, filed Nov. 27, 2002, which application claims benefit of U.S. Provisional Application Ser. No. 60/334,210 filed Nov. 30, 2001. Both applications are incorporated herein in their entirety.

The present invention relates to a support garment for quadrupeds. More specifically, the support garment of the present invention includes a neoprene laminated fabric material that includes support channels that allow for insertion of support rods. The support garment of the invention is effective for adjustably allowing for normal range of motion against resistance while preventing abnormal movement at the stifle joint, while not slipping off during movement by the animal.

### BACKGROUND

Injuries to animals, such as canines, can occur as a result of vehicle accidents and other sorts of trauma, or do to wear and tear because of stresses placed on susceptible areas. As in humans, the injured area may need to be immobilized in order to promote healing. However, it is often desirable for the animal to retain some degree of mobility during the healing process.

The amount of mobility desired during the healing process may change. As an animal's injury heals, it may be desirable to increase the animal's mobility in order to promote rehabilitation of the part, and help the animal regain some of the flexibility and strength that it may have lost.

Care for animals, after surgery also presents problems. Animals paw, lick and bite at wounds, often tearing out stitches or sutures. Such behavior results in the possibility of re-stitching a wound as well as an increased rate of infection at the wound site. Moreover, constant re-application of bandages to a wound, by taping gauze onto an animal has been difficult. Indeed, medical tape and gauze do not adhere well to the fur of a skittish animal.

Some attempts have been made to provide various types of shields, braces and splints for animals. For example, U.S. Pat. No. 6,267,083 describes a spinal support garment. Further, a cylindrical splint for use on the leg of a dog is described in U.S. Pat. No. 4,510,888.

These types of braces, heretofore, however, have suffered significant problems. They are difficult to put on and remove, and they often constrain the animal's normal range of motion more than is desirable. Further, none of these braces are adjustable such that the degree of mobility can be changed over time. Moreover, these body coverings often exacerbate rather than abate the irritation at the site of the injury.

### SUMMARY

The present invention is directed to a support garment for quadrupeds that is particularly effective for the treatment and rehabilitation of rear leg injuries. The garment is formed from a composite laminate fabric that is tough, resilient and waterproof, and that is flexible enough to allow for easy fitting of the garment and is comfortable for the animal to wear. The support garment is effective for preventing abnormal motion at the animals stifle joint, as well as the leg above and below this joint, but is adjustable such that the degree of normal motion allowed can be changed over time. The garment is effective for protection of wounds during a healing phase, protection of surgical sites, enhancing healing after osteotomy procedures, maintenance of bandages, protection from licking and biting of hot spots, and for the support of injured limbs during recovery. The garment of the invention washes and dries quickly and easily. Moreover, the garment maintains its shape and fit and defies shrinking, even upon repeated washing and continued wear.

The support garment of the present invention is formed from a three layer laminate material. The garment includes a support sleeve with lateral side panel sections and openings designed to fit around the leg and hindquarter sections of the animal. The support sleeve includes at least one longitudinal rod channel on each lateral side of the sleeve. The longitudinal rod channels are generally parallel to the quadraped's leg when the support garment is fitted onto the animal. Support rods of different stiffnesses may be slidably inserted into the rod channels to provide a desired level of immobilization.

The sleeve of the support garment is secured to the animal's leg with fasteners and/or straps. Additional and adjustable tensioning of the support sleeve may be provided by a butress strap secured around the sleeve. The butress stap is effective for adjustably tensioned support for the appendage to prevent anterior movement of the tibia on the femur.

In one aspect, the support garment may be designed to be interchangeable so that either two support sleeves, one for each leg may be fitted together or an alternate leg sleeve to stabilize the garment around the opposite leg. In this aspect, the opposite leg sleeve or the second support sleeve is continuous or attached to the first support sleeve by a snap or other attachment and fits around an opposite leg of the animal.

The support garment may also be further secured to the animal by use of a support tether. The support tether includes a superior tether, an inferior tether and fasteners. The support tether connects to the support garment and then extends around the neck and/or shoulders of the animal to further secure the support garment to the animal.

In an important aspect, the garment is made of a composite fabric that includes an inner lycra/nylon layer, a middle neoprene layer and an outer Velcro ready loop layer. The lycra/nylon material is on the interior portion of the garment that contacts the animal to provide a comfortable and nonirritating surface. The closed or open cell neoprene material forms the next layer of the garment and may further include on its exterior surface fasteners for securing the garment to the animal. In this aspect of the invention, the garment closes with fasteners, for example, hook and loop fasteners like the fasteners sold under the trademark “Velcro”, which are positioned strategically. In another important aspect, the exterior neoprene surface is further laminated with a Velcro compatible loop. The compatible loop laminate layer allows fasteners to be positioned at any part of the garment.

In another aspect, the invention provides a method for supporting an appendage of a quadraped. In using the support garment of the invention, tension rods of predetermined flexibility may be inserted into longitudinal rod channels on either side of the support sleeve. The support sleeve is positioned around the animals legs and secured. In one aspect of the invention, an opposite leg sleeve which is continuous and/or attached to the support sleeve is positioned on the opposite leg of the animal and further secured. In yet another aspect of the invention, the support garment can be further secured by attaching the support garment to a support tether. The support tether may be secured around the neck and shoulders of the animal.

### BRIEF DESCRIPTION OF THE DRAWINGS

FIGS. 1a and 1b shows a three dimensional view of one aspect of the support garment as worn by the animal.

FIG. 2 shows a flat pattern view of one aspect of the support garment.

FIG. 3 illustrates one aspect of the support sleeve.

FIG. 4 shows a flat pattern view of one aspect of the support sleeve.

FIGS. 5 and 6 illustrate a method for using the support garment of the present invention.

FIGS. 7A and 7B show a three dimensional view of one aspect of the support garment as worn by the animal.

FIG. 8 shows a top view of the support garment as worn by the animal.

FIG. 9 is a side view of a harness

FIG. 10 is a side view of the support garment.

FIGS. 11A and 11B illustrate tethers and support rods.

### DETAILED DESCRIPTION

The support garment of the present invention is useful in conjunction with a number of different rehabilitation and treatment procedures. The support garment may be used after surgery for immobilization and subsequent rehabilitation. In this aspect, the support garment is effective for minimizing post-operative complications following cruciate surgery.

The support garment may also be used for rehabilitation and in situations where no surgery has occurred for rehabilitation purposes. In this aspect, the support garment is effective for protecting the injured site while enhancing rehabilitation as healing occurs.

Further, the support garment may be used to stabilize and subsequently rehabilitate a joint where a spinal injury or fracture has occurred. For example, the support garment allows management for inoperable dogs. The support garment is also effect for decreasing osteoarthritis progression following cruciate injury.

More specifically, the support garment is effective as an anti-translational cruciate brace that prevents anterior translation of the tibia on the fermur when a “cranial” or “anterior” cruciate injury has occurred. Further, the support garment may be used to rehabilitate partial tear cruciate injuries, immobilize broken bones, stabilize or immobilize the knee joint, prevent patella sublexations or dislocations, protect extracapsular cruciate repairs and osteotomy procedures during the healing phase, aid in protecting the stifle joint when surgical treatment is to great a risk do to age or health issues, and other similar types of procedures.

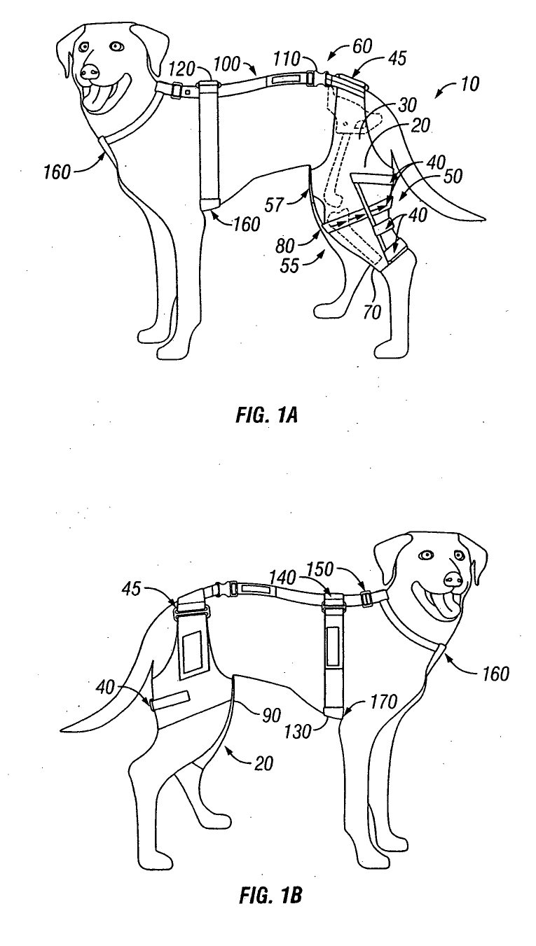

FIGS. 1a and 1b show a three dimensional view of the support garment as worn by the animal. The support garment 10 includes a support sleeve 20 and lateral side panel sections 30 and leg openings which are fit around the animals leg and which are secured with fasteners 40. The support garment 10 may also include dorsal fasteners 45 which are effective for further securing the garment.

The support sleeve 20 may be a single piece into which the animals leg is inserted. The back 50 or front 55 portion of the support garment 10 may include an insert which is a single type of fabric, such as for example a lycra/nylon material. The insert allows greater comfort, ease of positioning of the garment on the animal, and adjustability in the garments width. In one aspect, the insert may be a stiffle window 57 on the front 55 of the sleeve 20 and/or a lycra gusset 58 in the back 50 of the sleeve 20. In an important aspect, the support garment does not obstruct waste discharges from the animal and does not need to be removed for this purpose.

In alternative aspect, the support garment 10 may open along a back portion 50 of the leg and along a top portion 60 to allow the support garment 10 to be easily positioned on the animal's leg.

In an important aspect, the support sleeve 20 includes at least one longitudinal support rod channel 70 on each side of the support sleeve 20. In this aspect, the support sleeve 20 includes at least one longitudinal support rod channel 70 on the side of the garment that is on the outside of the animals leg, and at least one support rod channel on the side of the garment that is on the inside of the animals leg. In an important aspect, the support garment 10 includes at least two support rod channels 70 on each side of the support garment. The support rods channels 70 are generally parallel to the animals leg, as shown in FIG. 1 may intersect the animals leg bones in several positions. A butress 80 may be used to provide further tensioning of the garment. The butress 80 may be a strap and may be slidably positioned up and down the support rods as contained in the support rod channel 70.

The rod channels 70 may include an underlayment layer. The underlayment layer acts to decrease irritation to the animal by the rods, allows rods to be more easily inserted into the rod channels, and prevents slippage of the rods once they have been inserted into the rod channels. In an important aspect, underlayment layer of the rod pocket is integrated into the dorsal brace strap/s to provide continuous lift to the brace when the dorsal brace straps are tightened.

In another aspect of the invention shown in FIG. 1b, the support garment 10 includes an opposite leg sleeve 90. The opposite leg sleeve 90 is effective for providing the garment with further support and positioning stability. The opposite leg sleeve 90 may be attached and/or continuous with the rest of the garment.

In another aspect, the support garment 10 of the invention may include a support tether 100 as shown in FIGS. 1a and 1b. The support tether 100 may include a fastener or tether/brace buckle 110 for securing the support tether 100 to the support garment 10. Extending from the tether/brace buckle 110 and towards the head of the animal is a superior tether strap 120. The superior tether 100 may contact a chest girth strap 130 that is adjustably connected to the superior tether 100 by a girth tri-slide connector 140. The superior tether 100 may be secured to the animals collar by a superior tether tri-slide connector 150. The chest girth strap 130 may extend around the animals chest and contact an inferior tether 160. The inferior tether 160 may be connected to the chest girth strap 130 by a inferior tether loop 170. The inferior tether 160 may extend to an connect to the animals collar.

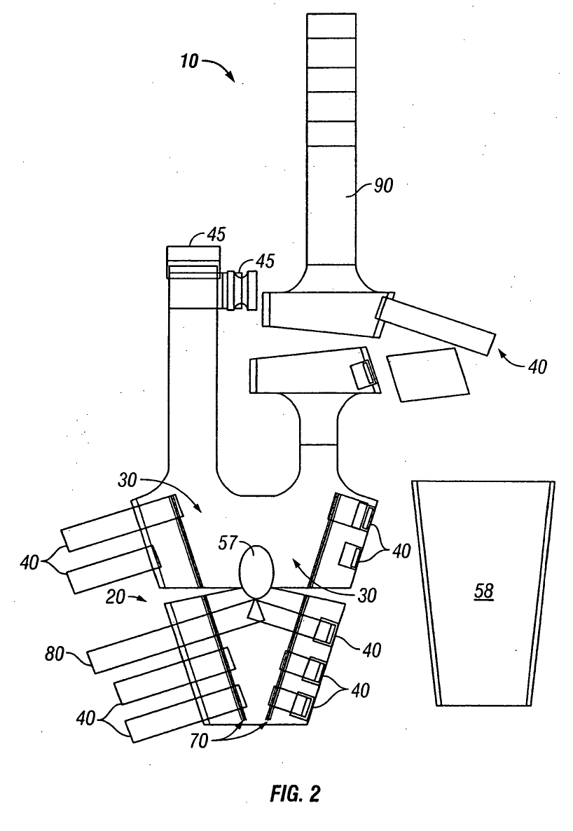

FIG. 2 shows a flat pattern view of the support garment 10 of the present invention. The support sleeve 20 of the present invention includes lateral side panel sections 30 and fasteners 40. As further shown in FIG. 2, the support garment 10 includes a continuous support rod channel 70 on each side of the support sleeve 20.

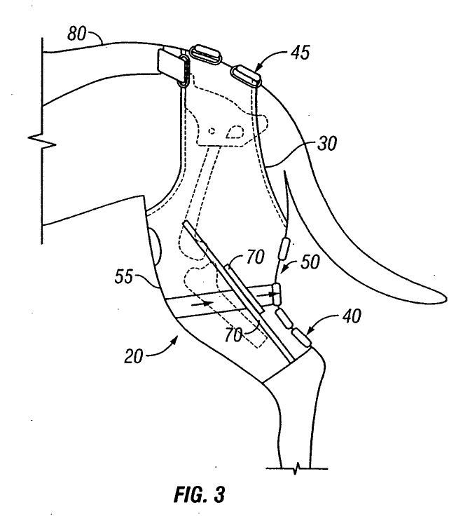

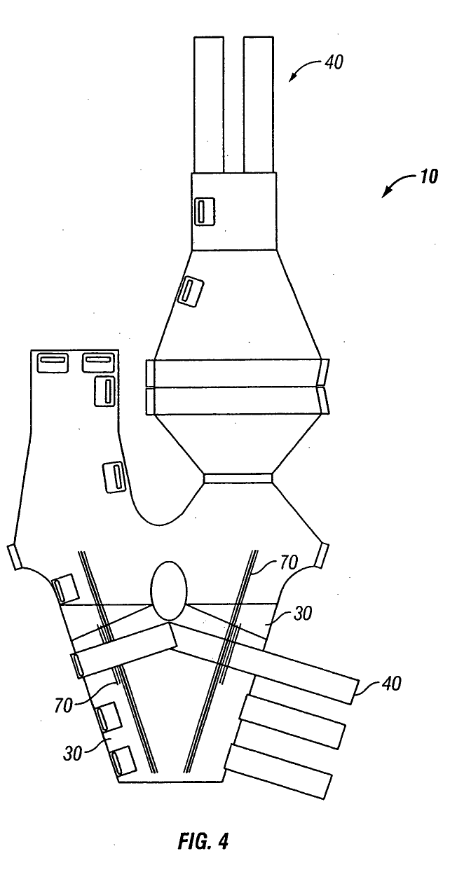

In alternative aspect of the invention illustrated in FIG. 3, the support sleeve 20 of the support garment 10 includes two support rod channels 70 on each side of the garment. The support rod channels 70 on each side of the garment are parallel to each other, but may overlap for a portion of their length. FIG. 4 is a flat pattern view of the support garment 10 shown in FIG. 3.

In another alternative aspect of the invention, the support garment 10 of the invention does not include support rod channels but includes means for attaching support rods to the support sleeve 20. The means for attaching the support rods may include a support rod channel 70 or may include fasteners 40 which can include for example straps. In this aspect, straps may be used to secure the support rod to the support sleeve.

Use of the Support Garment

In most situations, the injury to the animal is first cleaned and treated. Support rods are slidably inserted into support rod channels 70 and the support garment 10 is further adjusted and secured with the fasteners 40. The support sleeve 20 of the invention is caused to be encircled about the leg and hind quarters of the animal and initially secured with fasteners 40 around the leg and top of the hindquarters of the animal. Positioning and adjustment is effective for achieving a desired immobilization while not causing discomfort to the animal or aggravating the treatment protocol by reducing circulation to the injury or wound. The support garment 10 may be further secured to the animal with an opposite leg sleeve 90 and support tether 100.

In one aspect of the invention, fasteners 40 are straps that can extend partially or completely around the support sleeve 20. The straps may go around and/or over the support rods. The combination of straps and butress 80 are effective for preventing or restricting movement.

Support Rods

The support garment is effective for various degrees of immobilization including preventing anterior motion of the tibia through the use of support rods slidably inserted into support rod channels on the exterior of the support garment. The support rods are effective for permitting flexion and extension at the stifle and for preventing anterior movement of the tibia on the femur. The support rods may also be used to completely immobilize the knee joint. The degree of immobilization may also be dependent on the type of support rod used, the stiffness of the rod and whether the rod has a hinge or cam. In one aspect, the rods allow for some motion, but the motion is against a resistance which aids in rehabilitation of the leg.

The use of support rods is based on the principle that between any two point of a flexible material the flexural modulus decreases the shorter the material becomes. When flexion is available over any length of the support rod, maximum flexion is available. However, when flexion is attempted around two short segments, flexion is greatly reduced.

The support garment functions through the use of semi-tubular support rods which are placed in a support rod channel 70 on the inner and outer side of the support sleeve 20. The support garment acts to maintain sagittal plane stability by posterior tethering of the support rods above and below the stifle. The garment utilizes a buttress strap 80 located between the two support rods, located over the proximal tibia, which resists anterior translation of the tibia on the femur.

In another aspect, the top of the support rod channel 70 may be open or closed. In the aspect of the invention where the top of the support rod channel 70 is closed, the support rod channel 70 may include a horizontal slit towards the bottom of the support rod channel 70, or an opening at the bottom of the support rod channel with a flap closure.

Either before or after positioning the support garment 10 on the animal, one or more support rods may be slidably inserted into the support rod channels 70. The support rods may be made of a rigid material in order to provide proper support, but may also have some amount of flexibility in order not to immobilize the animal. Rigid or semi-rigid plastic is preferred, although other materials such as fiberglass, wood and metal may also be used. The choice of material and its flexibility is dependent upon the amount of immobilization desired. Thinning of the support rods may increase flexibility in desired areas (i.e. the knee joint/stifle), and allow for greater range of motion at the stifle without increasing the amount of antitranslation of the tibia on the femur.

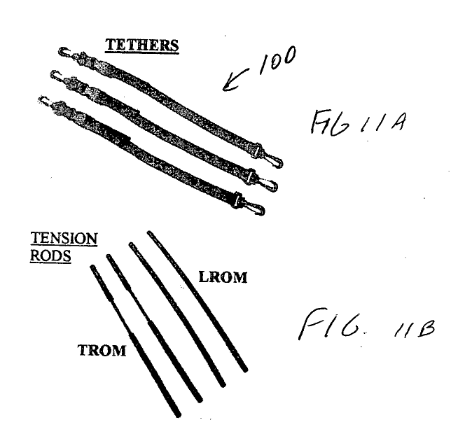

In an alternative aspect, a support rods may be hinged such that it is flexible or moveable at the stiffle. Further, a support rods may include a cam or ratchet arrangement near the knee joint section to allow for an adjustable and specific circumference of movement. As shown in FIG. 11B the support rods may be a continuous piece of similar thickness. Alternatively, the support rods may have a varied thickness throughout their length to effect different degrees of tensioning.

Support rods may be provided that provide a limited range of motion (LROM) as shown in FIG. 11B. The LROM rods have a increased rigidity which is effective for a more complete immobilization. Alternatively, support rods may be provided that provide a total range of motion (TROM) as also shown in FIG. 11B. The TROM rods have more flexibility which is effective for allowing more normal range of motion. During the course of treatment, LROM rods may be replaced with TROM rods as appropriate in the rehabilitation process.

In an important aspect, the invention allows the degree of immobilization, restraint, or anterior translation desired for a certain joint on a certain size animal to be completely customized based on the choice of support rod thickness and support rod material being utilized. In one aspect of the invention, support rods may be either 3/16, ¼, or 5/16″ inch plastic rods milled or dye extruded or dye cast, to a semi-tubular shape which provides stability for the rod in the rod channel. The thicker rods are used for larger dogs and the thinner rods are used for smaller dogs. The final thickness of the rod shall dictate the stiffness and degree of immobilization, the rod is used for. Further narrowing of these rods at the region of the rod that when placed in the rod channel coincides with the stifle joint, will allow for increased range of motion at that location, while maintaining its previous stiffness above and below the stifle joint.

In another important aspect, two support rod channels 70 are parallel to each other but may overlap over a portion of their length. The support rod channels 70 may be buttressed against one another to further decrease the flexion of both rods about the tethered portion of the rods. The overlap portion of the support rod channels 70 will vary depending on the size of the garment, but will generally be about one inch. The overlaping design of the support rod provides an additional degree of immobilization and support. Further, as indicated above, additional machining of the support rods may increase flexibility in desired areas (i.e. the knee joint/stifle), and or allow for less stringent restraint of motion on the stifle joint in smaller animals.

In another important aspect of the invention, support rods are removable and changeable to allow adjustment of the degree of resistance to flexion while still preventing anterior translation of the tibia during rehabilitation of the leg.

Garment Material

In an important aspect, the garment of the invention includes a three layer laminate material with the inner layer next to the animal being a lycra/nylon material, the middle layer being neoprene, and the outer layer being a Velcro ready loop. The inner lycra/nylon material of the garment forms a sleeve. This lycra/nylon sleeve “gusset” is effective for allowing easier application of the garment, and for comfort of the brace around the entire leg.

In this aspect, for example, the size of the garment, for example large, medium or small, represent the stature of the animal within a given range. Each size is adjustable to fit different diameter of leg within that general size classification.

The fasteners and fabric of the present invention are effective for allowing the garment to conform closely but comfortably to the leg as well as providing adjustability for different leg circumferences. A given size garment is adaptable to fit an animal of a certain height range and legs of a certain circumference range. When that size is exceeded the next size is chosen.

In another important aspect, the outer surface of the garment may include a Velcro ready loop that is laminated to the neoprene material. The Velcro ready loop may cover the entire surface of the garment or be laminated to selected areas. The Velcro ready loop allows fasteners to be placed anywhere as needed on the garment to conveniently and quickly secure the garment to the animal.

Fasteners

In another aspect, the fasteners of the invention may include hook and loop fasteners such as those sold under the trademark “Velcro”. Other fasteners, such as zippers, snaps, tri-slide connectors, buckles, loops and ties may also be used. In a very important aspect, Velcro or other similar hook and loop products may be used as the fastener due to its ease of use and its ability to act as a two-sided fastener. Fasteners such as straps may go partially or all the way around the support sleeve.

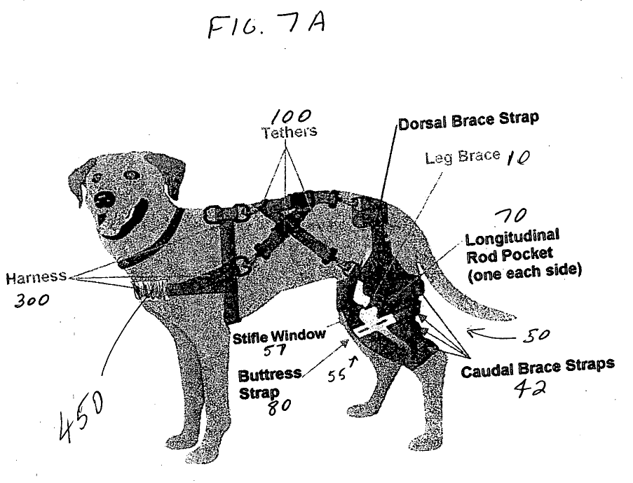

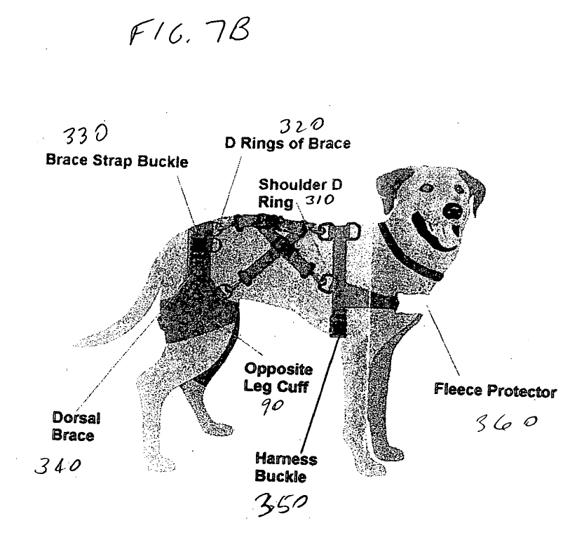

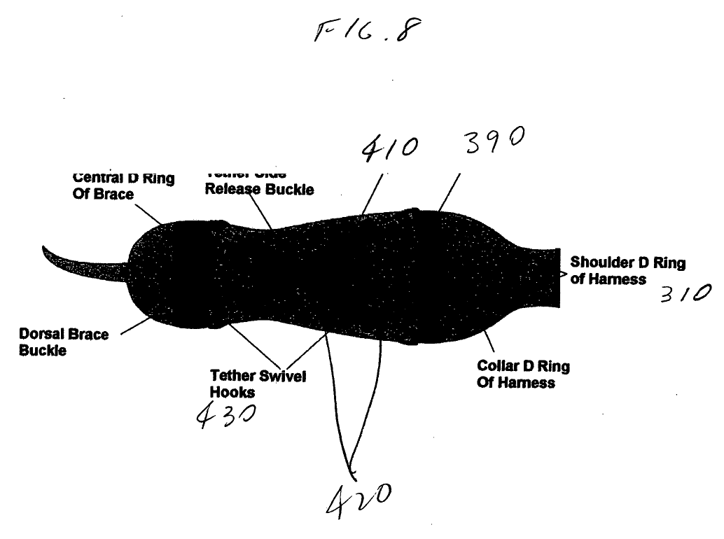

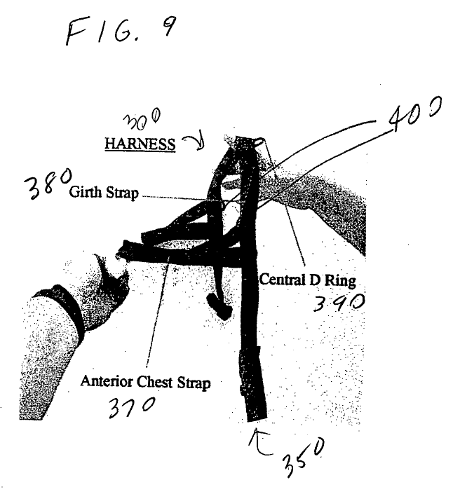

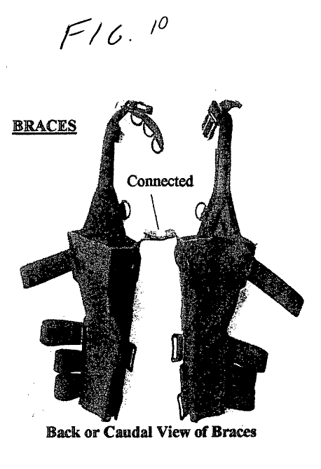

Straps which may be utilized may be formed of neoprene. Alternatively, polypropylene may be blended to the strap material to make the straps less stretchable and to provide more of a securing pull on the garment. As shown in FIGS. 7 through 10, D-rings which may be used in combination with snaps may be included in the garment design to make the government more secure and more adaptable to different size and shapes of an animal.

In one aspect, tethers (for examples as shown in FIG. 11A) are effective to prevent slippage and movement of the brace when connected to a harness or round the dogs chest or neck. The tether may be used in combination with swivel hooks and buckles. Importantly, multiple D-rings and hooks can be used such that the brace can be securely fitted to the animal and adjusted so that at least one combination of D-rings and hooks or buckles is located in the center of the animals back. Further, various combination of tether can be used, for example a tether formed of polypropylene may be attached to tethers formed of neoprene to provide a desired fit.

In an important aspect of the invention the tether is constructed in two parts, one part of a relatively small length of neoprene, and the other of a relatively long length of polypropylene. Each part has a swivel hook on one end and a either the male half or the female half of a side or top release buckle on the other end. The small portion of neoprene acts as a shock absorber when the dog moves. The polypropylene section acts as the adjustable side of the tether so that the tether can be adjusted to any length. The swivel hook on one end of the tether connects one end of the tether to the harness, collar or other device on the front of the dog, and the other swivel hook on the opposite end of the tether connects to any of the D rings on the on the brace.

In another important aspect of the invention a harness to be used with the brace to prevent backward shifting of the brace is constructed of ¾″, 1″, or 1.5″ of polypropylene webbing the construction of which is shown in FIG. 9. The D rings located at the superior portion of the girth strap allow for attachment of the central tether and for an optional connection via a tether to the dogs collar. Two additional D rings at location X and X allow for attachment of two additional tethers for further connection to the brace at any D ring position. To provide for additional padding and to reduce abrasion to the dog a loop fastener is placed over the anterior chest strap at one or multiple locations to accept a circular piece or pieces of fleece which have the attached corresponding hook fastener on its interior. The tubular fleece which is slit down one side and has both hook and loop closure on its opened ends so it can be closed around the anterior chest strap after it is connected via its hook closure to the loop closure on the anterior chest strap (See FIG. 7A).

In another important aspect of the invention the superior dorsal brace strap has a Y shaped connection to the rod pocket. This additional connection to the rod pocket gives the rod more stability, and directs the flexion of the rod more directly over the stifle joint. In another important aspect of the invention the rod pockets have openings at their inferior aspects with Velcro or Hook closures. This gives the dog owner the ability to remove and or replace the rods without removing the brace in its entirety.

The following examples illustrate methods for carrying out the invention and should be understood to be illustrative of, but not limiting upon, the scope of the invention which is defined in the appended claims.

### EXAMPLES

### Example 1

### Use of the Support Garment

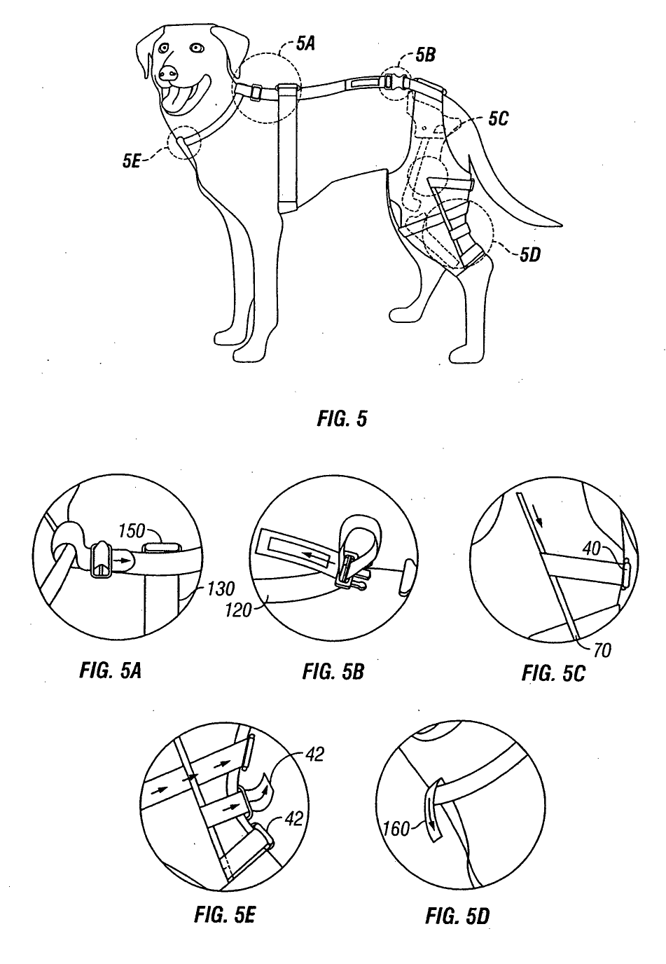

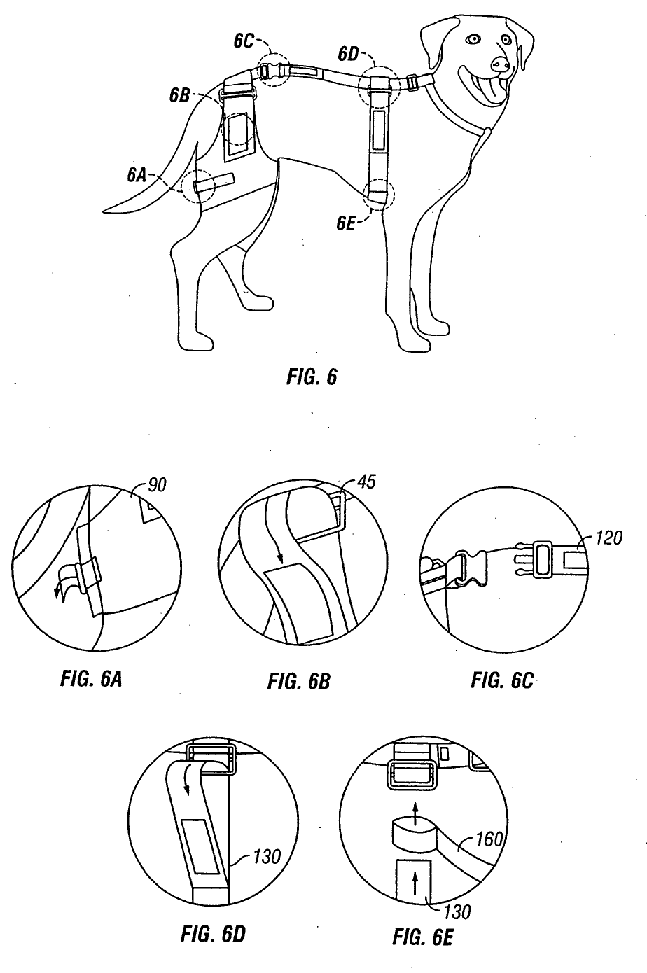

A method for using the support garment of the present invention is illustrated in FIG. 5.

Before applying the support garment, the support sleeve 20 and opposite leg sleeve straps are placed through the buckles (do not stick Velcro® closures down), and allowed to hang loosely. (As in step #10). The dog's collar should be on (Paragraph numbers relate to callout numbers in FIG. 5).

1. Tension Rods are placed into the longitudinal support rod channels 70. One tension rod goes in the longitudinal support rod channel 70 on the inside of the support sleeve 20, and one on the outside. One tension rod should not be used alone and a matched set of tension rods should be used.

If it is necessary for any reason to remove or change the tension rods once the support garment is in place (i.e., dog can't lay down at night), the following modification are used. The outside tension rod may be removed from the top of its rod channel 70. After inserting the tension rods, a scalpel may be used to make a small slit in the last (most distal) strap. The slit should be centered over the longitudinal rod channel without cutting the stitching (see call out #10). A slit is made only over the inside rod pocket. To remove the inside tension rod, the lowest strap and buckle are loosened, pull on the distal end of the brace, and work the rod out the distal slit. Reverse the process to put the Tension Rod back in).

2. The cranial end of the superior tether 120 is slipped under and then over the dog's collar. Place the free end up through the first opening and then down through the second opening of the plastic Tri-slide. Adjust so its length just allows the chest girth 130 to go (caudal) just behind the dog's legs.

3. Place the end of the chest girth 130 through the loop in the inferior tether 160 so the sewn edge of the loop faces down. Slide the inferior tether 160 down to the underside of the dog.

4. Place the free end of the chest girth 130 through the open end of the Girth Tri-Slide, pull until Girth is under mild/moderate tension. Stick the Velcro® down to the outside of the chest girth 130 to secure.

5. Take the loose end of the inferior tether 160 now connected to the chest girth 130 and loop it under and over the bottom of the dog's collar. Secure it to itself with the Velcro® closure on its end.

Gently slip the support sleeve 20 over the affected leg so the stifle window 57 is facing in a forward (cephalad) direction.

Being careful to stabilize the dog, gently place the unaffected leg through the opposite leg sleeve 90.

6. Secure the support garment dorsally by placing the dorsal brace flap through the dorsal fastener 45 and secure it to itself with the Velcro® closure on its end.

7. Adjust the superior tether's 120 posterior male connector, so that when connected to the female connector the tether is under tension. The superior tether 120 should cause the dorsal brace flaps to angle in a slightly forward direction.

8. Place the male connector on the superior tether 120 into the female connector on the brace connecting the buckle.

9. After making sure the opposite leg sleeve 90 is at the top of the unaffected leg, place the Velcro® strap through the buckle at the back of the opposite leg sleeve 90 and tighten under mild tension.

10. Now make sure the support sleeve 20 is at the highest point of the leg. Encircle hands around the top of the support sleeve 20 and leg and lift upward. Hold the support sleeve 20 in this position with one hand on the front of the support sleeve 20 while tightening the Velcro® straps with the other. Make sure the stifle window 57 is centered on the anterior aspect of the leg. First, tighten the second strap from the top, then the third (this will prevent the sleeve from slipping down), then the first, and then the remaining straps. Beginning at the top strap, go back over each strap one at a time making sure that each are snug. The strap ends should lay down flat and in line with themselves.

Palpate the stifle joint to make sure the proximal end of the tibia is withing the stifle window 57.

### Example 2

### Protocol for Rehabilitation of Partial Tear Cruciate Injuries

1. For acute injuries, the support garment should be used continuously with the stiffest tension rod for two weeks.

2. Follow up in two weeks and begin use of more flexible tension rod. Continuous use should continue for an additional six to eight weeks.

3. After the eight to ten weeks of continuous wear, the support garment should be worn as protection when greater amounts of activity are expected. The support garment can be worn with or without tension rods depending upon level of activity, weight of the dog, and other factors.

### Example 3

### Protocol for Acute Complete Tear Cruciate Injuries When Surgical Intervention is not Possible

1. The support garment is applied as soon after injury as possible. (Ice can be applied over brace). The stiffest tension rods should be utilized continuously for three weeks.

2. Follow up in three weeks and begin use of more flexible tension rod. Continuous use should continue for an additional three to five weeks.

3. After the six to eight weeks of continuous wear, the support garment should be worn as protection when greater amounts of activity are expected. The support garment can be worn with or without tension rods depending upon level of activity, weight of the dog, and other factors.

### Example 4

### Protocol for Chronic Complete Tear Cruciate Injuries When Surgical Intervention is not Possible

1. As no primary repair is anticipated, the support garment should be used to allow the dog to be more mobility and minimize pain. Therefore, attempts should be made to try different combinations of the support garment by itself and with each of the different tension rods to determine which maximizes the dog's comfort and mobility.

### Example 5

### Protocol Following Extra Capsular Cruciate Repair

1. The support garment is to be applied as soon after surgery as possible. (Ice can be applied over brace). The stiffest tension rods should be utilized continuously for three weeks.

2. Follow up in three weeks and begin use of more flexible tension rods. Continuous use should continue for an additional three to six weeks.

3. Following the six to nine weeks of continuous use, the support garment can be used with the more flexible tension rods or without the tension rods for additional support and protection when more strenuous activity is anticipated.

### Example 6

### Protocol Following TPLO Procedures

1. The support garment is to be applied immediately after or as soon as possible following the surgical procedure. The support garment with the stiffest tension rods should be utilized continuously for four to six weeks.

2. Follow up in six to eight weeks (earlier follow ups for suture removal etc., may be required). Begin the use of more flexible tension rods. Continuous use should continue for an additional six to eight weeks.

3. Following the ten to fourteen weeks of continuous wear, the support garment can be used with the more flexible tension rods or without tension rods for additional support and protection when more strenuous activity is anticipated.

### Example 7

### Use of thhe Support Garment

A method for using the support garment of the present invention is illustrated in FIG. 7A-B and 8.

1. The harness 300 is oriented to the dog. The harness buckle 400 should hang down and the D rings 390 and 400 should be on top and on the side. The anterior chest strap 370 should be facing forward. The central D ring 390 of the harness 300 should be located over the center of the dogs back. The harness 300 may include a fleece 450 attached, for example with Velcro, to the harness 300 to enhance the comfort of the harness.

2. The girth strap 380 is buckled under the dog and tightened such that about one finger can be placed under the strap.

3. The shortest tether 100 is hooked to the central D Ring 390 of the harness 300. The remaining two tethers 100 are hooked to the shoulder D rings 400 of the harness 300.

4. The brace 10 and opposite leg sleeve 90 or second brace are hooked together. All straps should be positioned to face in the same direction.

5. Tension Rods are placed into the longitudinal support rod channels 70. One tension rod goes in the longitudinal support rod channel 70 on the inside of the support sleeve 20, and one on the outside. One tension rod should not be used alone and a matched set of tension rods should be used.

6. The caudal brace straps 42 are place through their buckle at the back of each brace 10 and allowed to hang loosely with the brace 10 fully open.

7. With the stifle window 57 facing forward (cranially), the brace 10 is placed over the affected leg and the opposite leg sleeve 90 or another brace is placed on the opposite leg.

8. Buckles are placed over the top of the dog an snugged in an amount effective to be just snug over the dogs back.

9. Loops that go around the brace are located and moved around the brace to a corresponding snap.

10. The central tether 410 is connected to the brace with D rings and tightened until straps are vertical.

11. Side tethers 420 (which are connected to the Shoulder D Rings 400) are passed over the dog's back to the brace or cuff on the opposite side and attached via their swivel hooks 430 to the Brace D Rings 320 (side tethers should criss-cross over the dogs back). The straps should be under neutral tension when adjusted.

12. The stifle is palpated to see if it lies in the proper position within the stifle window 57. The distal portion of the femoral condyles should not lye inferior to the inferior edge of the stifle window 57 and the superior edge of the tibia should not be palpable in the superior ⅓ of the stifle window 57.

13. Each brace is grasped between the thumb and forefinger of both hands and the brace is gently lifted to as high a position on the thigh as it can go with buckling the material. The brace straps are tightened to maintain that position. The same operation to the brace or cuff is perfomed on the opposite leg. This may need to be repeated to obtain optimal position.

14. If after performing the above maneuver the superior edge of the brace still wants to sit slightly down from the top of the thigh (½″ to ¾″), and the stifle is sitting properly in the stifle window 57, this is acceptable. Next tighten the strap to finger tip tightness. Tighten the brace straps located above the buttress strap. Tighten the bottom one or two caudal brace straps last. If necessary go back to the harness, tethers, and caudal brace straps to make final adjustments. However, do not over tighten. In order to function properly, the brace only needs to conform to the leg, not squeeze it.

Numerous modifications and variations in practice of the invention are expected to occur to those skilled in the art upon consideration of the foregoing detailed description of the invention. Consequently, such modifications and variations are intended to be included within the scope of the following claims.

1. A support garment for quadrapeds comprising:
a support sleeve made of a three layer laminate material;
fasteners effective for closing the support sleeve around a quadraped's leg; and
at least one longitudinal rod channel on each lateral side of the support sleeve.

2. The support garment of claim 1 wherein the longitudinal rod channels are generally parallel to the quadraped's leg.

3. The support garment of claim 1 further comprising support rods.

4. The support garment of claim 3 wherein the support rods are continuous.

5. The support garment of claim 3 wherein the support rods are hinged.

6. The support garment of claim 3 wherein the support rods include a cam.

7. The support garment of claim 1 wherein the three layer laminate material includes an inner lycra/nylon layer, a middle neoprene layer, and an outer Velcro ready loop layer.

8. The support garment of claim 1 wherein the garment further comprises a butress strap effective for adjustably tensioned support for the appendage.

9. The support garment of claim 1 wherein the garment further comprises a second support sleeve on an opposite appendage.

10. The support garment of claim 1 wherein the garment further comprises a opposite leg sleeve effective for supporting the garment on the quadraped's appendage.

11. The support garment of claim 1 wherein the garment further comprises a support tether.

12. The support garment of claim 1 wherein the support tether comprises a superior tether, an inferior tether and fasteners.

13. The support garment of claim 1 wherein the support sleeve includes two parallel longitudinal rod support channels on each lateral side of the support sleeve.

14. A support garment for quadrapeds comprising:
a support sleeve made of a three layer laminate material, the support sleeve including lateral side panels and openings which are effective for allowing the support sleeve to be encircled around a quadraped's leg;
fasteners effective for closing the support sleeve around a quadraped's leg;
at least one longitudinal rod channel on each lateral side of the support sleeve; and
an opposite leg sleeve connected to the support sleeve, the opposite leg sleeve effective for supporting the support garment on the quadraped's leg.

15. The support garment of claim 14 wherein the longitudinal rod channels are generally parallel to the quadraped's leg.

16. The support garment of claim 14 further comprising support rods.

17. The support garment of claim 16 wherein the support rods are continuous.

18. The support garment of claim 16 wherein the support rods are hinged.

19. The support garment of claim 16 wherein the support rods include a cam.

20. The support garment of claim 14 wherein the three layer laminate material includes an inner lycra/nylon layer, a middle neoprene layer, and an outer Velcro ready loop layer.

21. The support garment of claim 14 wherein the garment further comprises a butress strap on the support sleeve, the butress stap effective for adjustably tensioned support for the appendage to prevent anterior movement of the tibia on the femur.

22. The support garment of claim 14 wherein the garment further comprises a support tether.

23. The support garment of claim 22 wherein the support tether comprises a superior tether, an inferior tether and fasteners effective for connecting to the support garment and for further securing the support garment to the quadraped.

24. The support garment of claim 14 wherein the support sleeve includes two parallel longitudinal rod support channels on each lateral side of the support sleeve.

25. A support garment for quadrapeds comprising:
a first and second support sleeve, each support sleeve being made of a three layer laminate material, each support sleeve including lateral side panels and openings which are effective for allowing the support sleeves to be encircled around a quadraped's legs;
fasteners effective for closing the support sleeves around a quadraped's legs;
at least one longitudinal rod channel on each lateral side of each support sleeve.

26. The support garment of claim 25 wherein the longitudinal rod channels are generally parallel to the quadraped's leg.

27. The support garment of claim 25 further comprising support rods.

28. The support garment of claim 27 wherein the support rods are continuous.

29. The support garment of claim 27 wherein the support rods are hinged.

30. The support garment of claim 27 wherein the support rods include a cam.

31. The support garment of claim 25 wherein the three layer laminate material includes an inner lycra/nylon layer, a middle neoprene layer, and an outer Velcro ready loop layer.

32. The support garment of claim 25 wherein the garment further comprises a butress strap on the support sleeve, the butress stap effective for adjustably tensioned support for the appendage.

33. The support garment of claim 25 wherein the garment further comprises a support tether.

34. The support garment of claim 25 wherein the support tether comprises a superior tether, an inferior tether and fasteners effective for connecting to the support garment and for further securing the support garment to the quadraped.

35. The support garment of claim 25 wherein the support sleeve includes two parallel longitudinal rod support channels on each lateral side of the support sleeve.

36. A method for supporting an appendage of a quadraped, the method comprising:
inserting at least one tension rod into an outside longitudinal rod channel and at least one tension rod into an inside longitudinal rod channel of a support garment;
positioning the support garment around an appendage of the quadraped; and
securing the support garment to the appendage of the quadraped.

37. The method of claim 36 wherein the longitudinal rod channels are generally parallel to the quadraped's leg.

38. The method of claim 36 further comprising support rods.

39. The method of claim 38 wherein the support rods are continuous.

40. The method of claim 38 wherein the support rods are hinged.

41. The method of claim 38 wherein the support rods include a cam.

42. The method of claim 36 wherein the support garment comprises a three layer laminate material that includes an inner lycra/nylon layer, a middle neoprene layer, and an outer Velcro ready loop layer.

43. The method of claim 36 wherein the garment is adjustably tensioned around the appendage using a butress.

44. The method of claim 36 wherein the garment is further secured by placing a second opposite appendage into an opposite leg sleeve.

45. The method of claim 36 wherein the garment is further secured by attaching the support garment to a support tether.

46. The method of claim 45 wherein the support tether comprises a superior tether, an inferior tether and fasteners.

47. The method of claim wherein the support sleeve includes two parallel longitudinal rod support channels on each lateral side of the support sleeve.

48. A support garment for quadrapeds comprising:
a support sleeve made of a three layer laminate material;
fasteners effective for closing the support sleeve around a quadraped's leg; and
a means for attaching a support rod on each lateral side of the support sleeve.

49. The support garment of claim 48 further comprising support rods that are generally parallel to the quadraped's leg.

50. The support garment of claim 49 wherein the support rods are continuous.

51. The support garment of claim 49 wherein the support rods are hinged.

52. The support garment of claim 49 wherein the support rods include a cam.

53. The support garment of claim 48 wherein the three layer laminate material includes an inner lycra/nylon layer, a middle neoprene layer, and an outer Velcro ready loop layer.

54. The support garment of claim 48 wherein the garment further comprises a butress effective for adjustably tensioned support for the appendage.

55. The support garment of claim 48 wherein the garment further comprises a second support sleeve on an opposite appendage.

56. The support garment of claim 48 wherein the garment further comprises a opposite leg sleeve effective for supporting the garment on the quadraped's appendage.

57. The support garment of claim 48 wherein the garment further comprises a support tether.

58. The support garment of claim 48 wherein the support tether comprises a superior tether, an inferior tether and fasteners.
